(19) United States
(12) Patent Application Publication
(10) Pub. No.: US 2024/0240956 A1
(43) Pub. Date: Jul. 18, 2024

(54) Analyzing Travel Metrics

(71) Applicant: Google LLC, Mountain View, CA (US)

(72) Inventors: Yan Borisovich Mayster, Aurora, CO (US); Bruce Bahnsen, Boulder, CO (US)

(21) Appl. No.: 18/011,923

(22) PCT Filed: Jul. 18, 2022
(86) PCT No.: PCT/US2022/037459

§ 371 Date: Dec. 21, 2022

(51) Int. Cl. G01C 21/36

(52) U.S. Cl. CPC G01C 21/3617

(57) ABSTRACT

The technology generally relates to a method for predicting travel metrics for a user for a predetermined time period based on a starting location and the user's travel history. The predicted travel metrics may include, for example, a time of travel, a distance traveled, travel expenses, carbon footprint, etc. The travel history may be based on location information detected by a device having location sensors. The location information may be used to identify relevant destinations frequented by the user and routine trips completed by the user. The identified destinations and trips may be used to determine predicted travel metrics.

### BACKGROUND

In determining whether to purchase or rent a new home, or to book a vacation stay, people sometimes map out various trips to gauge the commute from the new home or vacation stay to one or more destinations. For example, someone may map out a route from a potential new home to work, or a route from a potential vacation stay to nearby attractions. To obtain more accurate information regarding traffic, travel time, and the like, the person can set the day of the week and the time of day for each trip. This may be cumbersome, requiring the person to individually map out every trip. Moreover, if considering multiple trips over a period of time, the person would have to manually aggregate the time and/or distance associated with each trip to determine the impact over the period of time.

### BRIEF SUMMARY

The technology generally relates to systems and methods for predicting travel metrics. The predicted travel metrics for a user may be for a predetermined time period and may be based on a new starting location and the user's travel history. The new starting location may be, for example, a potential new home address, a vacation destination address, or another address different than the user's existing starting location. The predicted travel metrics may provide an indication illustrating how the new starting location will affect the user's overall travel. The predicted travel metrics may include, for example, a time of travel, a distance traveled, travel expenses, carbon footprint, etc. Location information, such as information detected by one or more location sensors in a user device, may be used to determine the travel history. For example, the location information may be used to identify relevant destinations frequented by the user and routine trips completed by the user. The relevant destinations and routine trips may be determined based on a threshold frequency of visits, an identifiable pattern of visits, etc. The identified destinations and trips may be used to determine one or more predicted travel metrics for the new starting location by calculating the travel metrics to the identified destination and to complete the identified trips using the new starting location instead of the user's existing starting location. In turn, the predicted travel metrics may be used to evaluate the impact of changing the starting location.

A first aspect of the technology is generally directed to a method comprising receiving, by one or more processors, location information corresponding to one or more places of interest for a user, determining, by one or more processors based on the received location information, routine trips, each of the routine trips including a trip starting location and one or more destination locations, and determining, by the one or more processors based on the determined routine trips, one or more predicted travel metrics.

The predicted one or more travel metrics may include at least one of a mileage, an amount of driving time, a carbon footprint, or a driving expense. Receiving the location information corresponding to the one or more places of interest for the user may further include receiving, by the one or more processors, the location information from at least one of memory of a user device, one or more servers, or navigational applications.

Determining the routine trips may comprise determining, by the one or more processors based on the location information, a pattern or a frequency of a plurality of trips, and identifying, based on the determined pattern or frequency of the plurality of trips, the routine trips. When identifying the routine trips based on the frequency of the plurality of trips, the method may further comprise comparing a frequency of a respective trip of the plurality of trips to a threshold frequency, wherein when the frequency of the respective trip is greater than the threshold frequency the respective trip is a routine trip.

The method may further comprise identifying, by the one or more processors based on the received location information, one or more relevant destinations, wherein the determined one or more travel metrics for the predetermined period of time is further based on the identified one or more relevant destinations. The method may further comprise providing, by the one or more processors based on the identified one or more relevant destinations, one or more alternative destinations, wherein the one or more alternative destinations reduce the determined one or more predicted travel metrics.

The one or more trips may occur during a predetermined period of time and the determined one or more predicted travel metrics is for a corresponding period of time.

The method may further comprise receiving, by the one or more processors, a new starting location different than an existing starting location of the user. The method may further comprise determining, by the one or more processors based on the determined routine trips and the existing starting location, one or more travel metrics, and comparing, by the one or more processors, the one or more predicted travel metrics and the one or more travel metrics. The method may further comprise outputting, by the one or more processors, the one or more predicted travel metrics and the one or more travel metrics.

A first destination location for a first trip of the routine trips may be different than a second destination location for a second trip of the routine trips.

Another aspect of the technology is generally directed to a device, comprising one or more processors. The one or more processors may be configured to receive location information corresponding to one or more places of interest for a user, determine, based on the received location information, routine trips, each of the routine trips including a trip starting location and one or more destination locations, and determine, based on the determined routine trips, one or more predicted travel metrics.

Yet another aspect of the technology is generally directed to a computer-readable medium storing instructions, which when executed by one or more processors, cause the one or more processors to receive location information corresponding to one or more places of interest for a user, determine, based on the received location information, routine trips, each of the routine trips including a trip starting location and one or more destination locations, and determine, based on the determined routine trips, one or more predicted travel metrics. The computer-readable medium may be non-transitory.

### BRIEF DESCRIPTION OF THE DRAWINGS

FIG. 1A is a pictorial diagram of an example of identifying relevant locations in accordance with aspects of the disclosure.

FIG. 1B is a pictorial diagram of example of predicted travel metrics in accordance with aspects of the disclosure.

FIG. 2A is a functional diagram of an example system in accordance with aspects of the disclosure.

FIG. 2B is a pictorial diagram of the example system of FIG. 2A in accordance with aspects of the disclosure.

FIGS. 3A and 3B are pictorial diagrams of an example of identifying routine trips and relevant destinations in accordance with aspects of the disclosure.

FIGS. 4A and 4B are pictorial diagrams of an example of identifying a threshold distance in accordance with aspects of the disclosure.

FIG. 5 is a pictorial diagram of example predicted travel metrics in accordance with aspects of the disclosure.

FIG. 6 is a pictorial diagram of example average travel metrics in accordance with aspects of the disclosure.

FIG. 7A is a pictorial diagram of example suggestions to reduce travel metrics in accordance with the disclosure.

FIG. 8 is a flow diagram for an example method of determining travel metrics in accordance with aspects of the disclosure.

### DETAILED DESCRIPTION

The technology generally relates to a method for predicting travel metrics for a user for a predetermined time period based on a starting location and location information for the user. The predicted travel metrics may assess many travel factors and provide a clear, concise illustration of the effect on the user's overall travel of changing the user's typical starting location to a new starting location. The predicted travel metrics may be, for example, predicted travel distances, time spent traveling, expenses associated with the travel, carbon footprint from traveling, etc. The location information may include destinations and trips from the user's existing starting location, such as the user's commute, grocery store visits, dry cleaners, coffee shop, etc. According to some examples, when the new starting location is more than a predetermined distance away from the user's existing starting location, comparable destinations closer to the new starting location may be used to determine the predicted travel metrics.

The predicted travel metrics may be used to evaluate the impact that changing the starting location has on a given travel metric. For example, the predicted travel metrics may provide an indication of the miles to be traveled, the amount of travel time, travel expenses, such as estimated cost of gas, tickets for public transportation, etc., the carbon footprint caused by the traveling, etc. that a user would experience when traveling their routine trips or to relevant destinations from the new starting location. The predicted travel metrics may be determined for a predetermined period of time, such as a day, a week, a month, a year, etc.

The new starting location may be a potential new home address, a vacation destination address, or any other address. The new starting location may be selected by a user, such as by selecting a point on a map or entering an address. In some instances, the new starting location may be automatically determined. For instance, the new starting location may be set to the address of a house or apartment in a sale or rental listing the user was viewing. In some examples, the starting location may be the user's current home address.

The user's location information may be used to identify places of interest for the user. Places of interest may be locations or destinations frequented by the user. In some examples, the location information may be used to identify the user's routine trips to destinations. Routine trips may be, for example, routes that the user travels at a given frequency or with a certain pattern, such as the user's commute to work, stopping at a coffee shop, weekly food-shopping trips, etc. Routine trips may include a starting location and a destination location. In some examples, routine trips may include a starting location and two or more destination locations. In such an example, the user's home address may be the starting location, a first destination location may be the local gym, and a second destination location may be the user's work address. Destinations may be, for example, locations frequented by the user. In some examples, the user's location information may be used to identify destinations or types of destinations, such as a pet groomer, nail salon, barber shop, pool supply store, etc.

Predicted travel metrics may be determined based on the starting location and places of interest for the user. For example, the system may determine routine trips taken by the user based on their location information. The system may, in some examples, determine destinations or destination types, such as food stores, nail salons, barber shops, etc. Based on the identified trips and destinations, the system may determine predicted travel metrics for a given starting location. For example, the system may determine a predicted number of miles, time spent traveling, travel expenses, carbon footprint, etc. for a user to continue making their trips or traveling to destinations from the given starting location. The predicted travel metrics may be output to the user. The given starting location may be the user's existing starting location, such as their current home address, or a new starting location, such as a potential new home address, a vacation destination address, etc.

In some examples, suggestions of alternative destination locations or times to travel may be provided in order to reduce the travel metrics. For example, the output may include suggestions to change the time a user leaves for work from their existing starting location from 7:15 am to 7:00 am in order to reduce travel metrics. In some examples, the output may include suggestions to switch destination locations of the same type, such as from one food store chain to another. The suggested new destination locations may be based on destination locations that would reduce travel metrics.

In yet another example, suggestions of alternative destination locations may be based on a threshold distance between the user's existing starting location and a new starting location. For example, if the new starting location is greater than a threshold distance from the user's existing starting location, the system may suggest alternative destination locations closer to the new starting location.

According to some examples, the output may include suggestions of starting locations or regions to relocate to in order to reduce the travel metrics to the destination locations. For example, the output may include an indication showing locations or regions that have the same predicted travel metrics as compared to a user's current travel metrics or predicted travel metrics that are less than the user's current travel metrics.

The user's current travel metrics may be determined automatically, without user input. For example, when the user authorizes location sharing the system may determine routine trips, relevant destinations, etc. based on the location information of the user and without specific user input for each trip.

By determining the current travel metrics for a user based on the user's existing starting location, and predicting travel metrics for a new starting location, the user can make a well informed decision to reduce their travel metrics. In some examples, the current travel metrics may be used to identify new starting locations that match user preferences to keep travel metrics under a threshold amount. Additionally or alternatively, the current travel metrics may be used to determine alternative destination locations that would meet or are below the threshold travel metrics. This may conserve resources by reducing fuel and/or electricity usage. In some examples, suggestions for alternative destinations locations may decrease travel expenses, time of travel, distance of travel, etc. for the user.

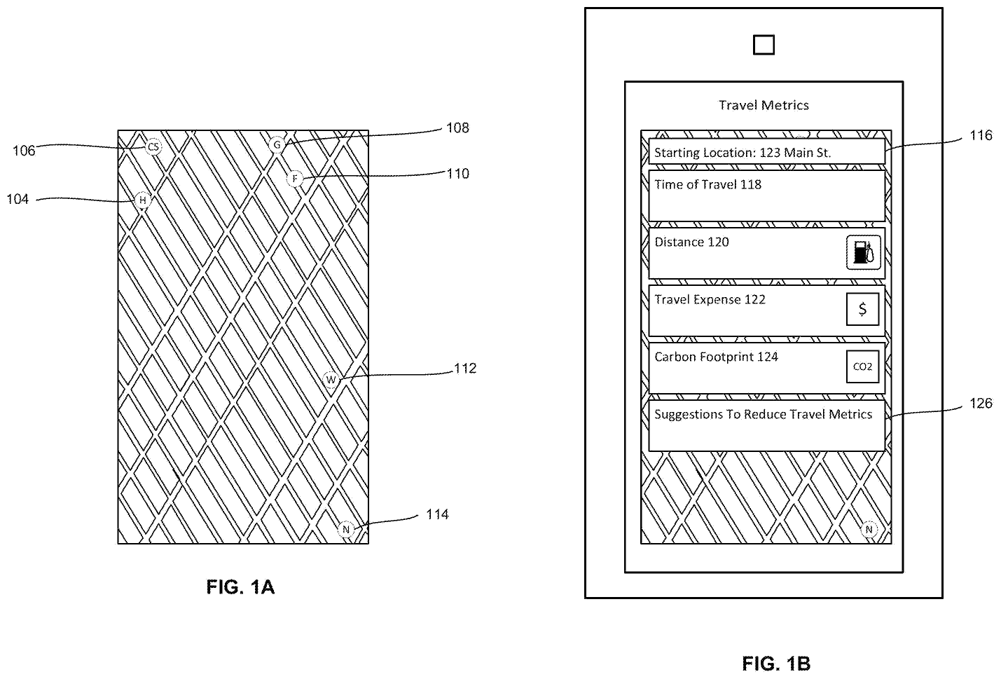

FIG. 1A illustrates an example of the user's location information. The location information may be the user's travel history. For example, the user's travel history may be based on location information provided by a personal device, a navigational system, a mapping application, etc. Location information may be, for example, data collected by a device having a location sensor, such as a global positioning system (GPS), which illustrates the locations a user has traveled to. In some examples, location information may include destinations identified e-mails, calendar appointments, etc. that the user has allowed the system access to.

Location information may be used after the user provides authorization for the system to access or receive location information. For example, the user may provide authorization to an application or the system to access one or more databases in the memory of the user's device, vehicle, remote server, etc.

The locations identified by the location information may correspond to destinations, such as the destination location of a trip or a relevant destination. The user's location information, such as the user's travel history, may be used to identify places of interest for the user, routine trips, relevant destinations, or destination types. The relevant destinations and routine trips may be determined based on a threshold frequency of visits, an identifiable pattern of visits, etc. As shown in FIG. 1A, the system may have identified the user's existing starting location 104, relevant locations such as the coffee shop 106, gym 108, food store 110, and work 112, and the new starting location 114. According to some examples, the system may identify routine trips taken by the user to the relevant destinations. The system may identify features of the trips, such as when the user leaves for the trip, the order of destinations in the trip, etc.

FIG. 1B illustrates an example of predicted travel metrics determined based on the user's location information. The predicted travel metrics may include, for example, the driving time 118, mileage 120, driving expenses 122, and carbon footprint 124 to continue frequenting the destinations for each routine trip or relevant destination using the new starting location. The predicted travel metrics may be a total amount of time, mileage, expense, carbon footprint, etc. to continue requesting the destinations for each routine trip or relevant destination.

The new starting location 114 may be based on an input received as a selection of a location on the map, an input of an address, a suggested starting location based on chosen travel metrics, etc.

According to some examples, the system may output an indication of the user's existing starting location 104, relevant locations identified based on the user's location information, such as coffee shop 106, gym 108, food store 110, and work 112, and a new starting location 114. In yet another example, the system may receive an input 116 corresponding to the new starting location 114 without displaying the existing starting location 104 or any relevant locations 106-112. In some examples, the system may receive an input identifying relevant locations to be included when predicting travel metrics for a new starting location.

Based on the user's location information, the system may predict travel metrics for the new starting location 114. For example, the system may predict the time of travel 118 based on the frequency the user completes the routine trips or travels to the relevant destinations. In some examples, the system may determine the expected time of travel based on the traffic and road conditions based on the typical time of travel for the routine trip or trip to the relevant destination from the new starting location 114. For example, the predicted traffic and road conditions may be based on the time of day, day of the week, etc. that the user typically travels to a given destination. The system may predict the time of travel by aggregating the time for each routine trip or trip to a relevant destination.

According to some examples, the system may predict the miles 120 traveled based on the user's location information. For example, based on the frequency at which the user completes the routine trips or travels to the relevant destinations, the system may aggregate the miles for each routine trip or trip to the relevant destination from the new starting location 114.

The system may use the predicted mileage 120 traveled to determine a predicted travel expense 122. The predicted travel expense 122 may include the predicted cost of gas, the predicted cost of using public transportation, etc.

In some examples, the system may, additionally or alternatively, use the time of travel 118 to determine the predicted travel expense. The system may determine the predicted travel expense 122 based on the cost of gas or public transportation in the area surrounding the new starting location 114. For example, the system may average the cost of gas from gas stations within a predetermined radius around the new starting location 114.

In examples where the user only drives and does not take public transportation, the system may divide the predicted mileage 120 traveled by an estimated fuel efficiency to determine the predicted travel expense 122.

According to some examples, the system may request information regarding the user's vehicle, such as the make and model of the vehicle. The system may use the information regarding the user's vehicle to determine the fuel efficiency of the user's vehicle. In yet another example, if the system is integrated into the vehicle's onboard navigational system, after the user authorizes the system access to the vehicle's information, such as the make and model of the vehicle, the vehicles estimated fuel efficiency, etc., the system may use the vehicle information when predicting travel metrics. The system may use the vehicle information and the predicted miles 120 and/or the time of travel 118 to determine the predicted travel expense 122.

In examples where the user drives and takes public transportation, the system may determine the predicted travel expenses 122 for the portion of travel that the user drives and for the portion of travel that the user takes public transportation. The predicted public transportation costs may be determined based on the public transportation and the cost of public transportation available near the new starting location 114.

The system may determine a predicted carbon footprint 124 based on the user's location information. For example, the system may determine the predicted carbon footprint 124 based on the predicted miles 120 traveled and an estimated fuel efficiency of the vehicle. For example, the predicted miles 120 traveled and the estimated fuel efficiency of the vehicle may be used to predict how much gas the vehicle uses in order to travel the predicted miles 120 traveled and, therefore, how much carbon dioxide is output to burn the predicted amount of gas.

The system may determine suggestions to reduce travel metrics 126. For example, the system may determine different destinations of the same type that would reduce one or more travel metrics. In such an example, the system may determine that going to food store closer to the user's work would reduce their time of travel and distance as compared to going to the food store the user currently visits. According to some examples, the system may suggest replacing driving one or more routine trips with taking public transportation to the destination of the routine trips. The suggestions may be to reduce travel metrics based on the new starting location 114.

While the examples of predicted travel metrics discussed above and herein are in reference to a new starting location 114, the system may determine one or more travel metrics based on the existing starting location 104. According to some examples, the system may determine the user's current travel metrics based on the existing starting location 104. The system may provide suggestions to decrease the user's current travel metrics. In some examples, the system may compare the user's current travel metrics to the predicted travel metrics determined based on the new starting location 114. The comparison may be used to show the effect of changing the starting location.

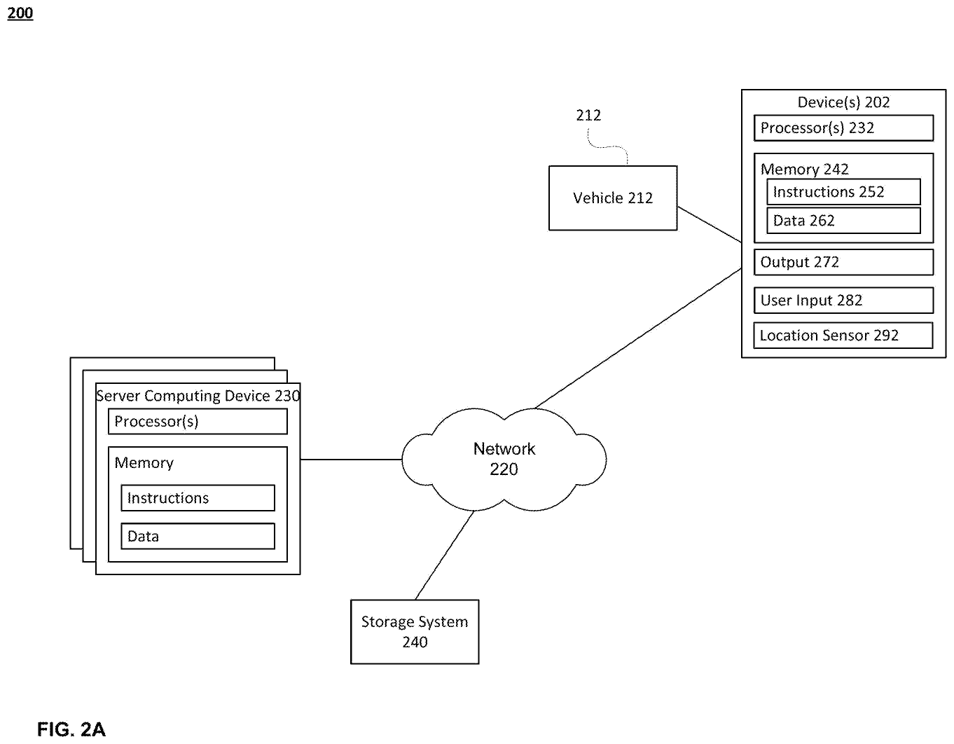

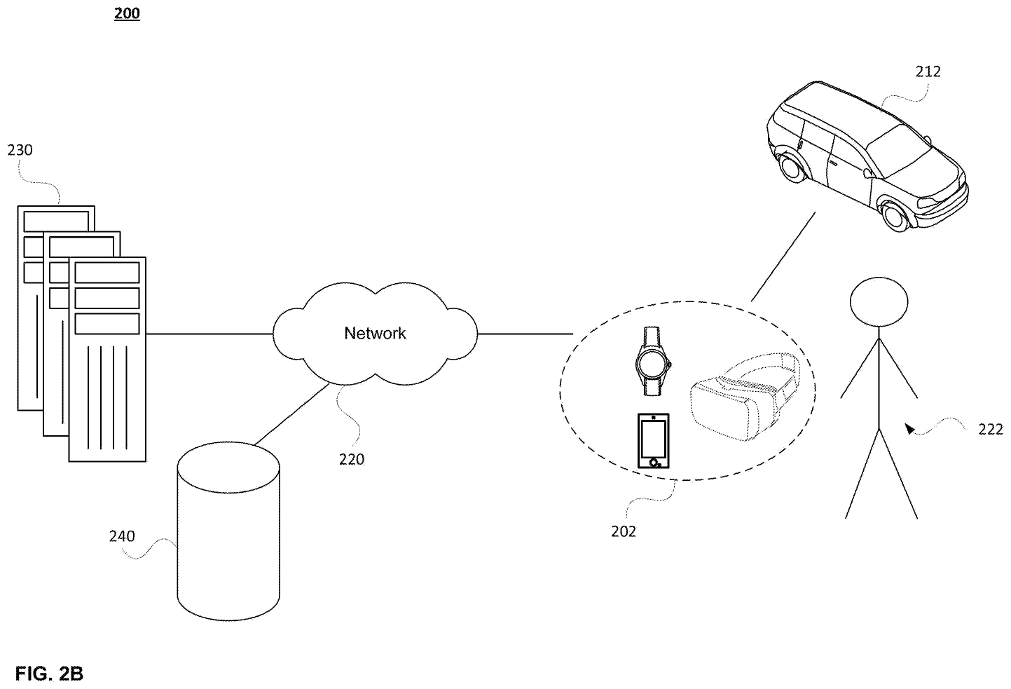

FIG. 2A illustrates an example system 200 in which the features described above may be implemented. It should not be considered limiting the scope of the disclosure or usefulness of the features described herein. In this example, system 200 may include device(s) 202, vehicle(s) 212, server computing device 230, storage system 240, and network 220.

Each of devices 202 may include one or more processors 232, memory 242, data 262 and instructions 252. Each of devices 202 may also include an output 272, user input 282, and location sensor 292292. The devices 202 may be any device that includes a location sensor 292292, such as a smart phone, tablet, laptop, smart watch, AR/VR headset, smart helmet, etc., as shown in FIG. 2B.

Memory 242 of devices 202 may store information that is accessible by processor 232. Memory 242 may also include data that can be retrieved, manipulated or stored by the processor 232. The memory 242 may be of any non-transitory type capable of storing information accessible by the processor 232, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 242 may store information that is accessible by the processors 232, including instructions 252 that may be executed by processors 232, and data 262.

Data 262 may be retrieved, stored or modified by processors 232 in accordance with instructions 252. For instance, although the present disclosure is not limited by a particular data structure, the data 262 may be stored in computer registers, in a relational database as a table having a plurality of different fields and records, XML documents, or flat files. The data 262 may also be formatted in a computer-readable format such as, but not limited to, binary values, ASCII or Unicode. By further way of example only, the data 262 may comprise information sufficient to identify the relevant information, such as numbers, descriptive text, proprietary codes, pointers, references to data stored in other memories (including other network locations) or information that is used by a function to calculate the relevant data.

The instructions 252 can be any set of instructions to be executed directly, such as machine code, or indirectly, such as scripts, by the processor 232. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 232 may include any conventional processors, such as a commercially available CPU or microprocessor. Alternatively, the processor can be a dedicated component such as an ASIC or other hardware-based processor. Although not necessary, computing devices 202 may include specialized hardware components to perform specific computing functions faster or more efficiently.

Although FIG. 2A functionally illustrates the processor, memory, and other elements of devices 202 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 202. Accordingly, references to a processor or device will be understood to include references to a collection of processors or devices or memories that may or may not operate in parallel.

Output 272 may be a display, such as a monitor having a screen, a touch-screen, a projector, or a television. The display 272 of the one or more computing devices 202 may electronically display information to a user via a graphical user interface (“GUI”) or other types of user interfaces. For example, as will be discussed below, display 272 may electronically display a map interface identifying relevant destinations, routine trips, or one or more travel metrics based on a specified starting location.

The user input 282 may be a mouse, keyboard, touch-screen, microphone, or any other type of input. The user input may receive the user's authorization to use the location sensor 292 to obtain location information for the travel metrics. For example, the user can select particular applications for which to allow location services, particular times during which location services can be enabled, or other permissions or limitations for the location services.

The location sensor 292 may be, for example, a global positioning system (“GPS”) sensor, wireless communications interface, etc. The location sensor 292, when enabled by the user, may provide a rough indication as to the location of the device. According to some examples, when authorized by the user, the location sensors may provide location information indicating relevant destinations or routine trips.

The location information may be stored locally on the device 202 or navigational system, such as part of an application or integrated into vehicle 212. In some examples, the location information may be shared to a remote location, such as a remote server 230 or storage system 240. According to some examples, the location information may be used to identify types of destinations visited and the frequency such that the system does not require or obtain the specific destination location.

The devices 202 can be at various nodes of a network 220 and capable of directly and indirectly communicating with other nodes of network 220. Although three (3) computing devices are depicted in FIG. 2A, it should be appreciated that a typical system can include one or more computing devices, with each computing device being at a different node of network 220. The network 220 and intervening nodes described herein can be interconnected using various protocols and systems, such that the network can be part of the Internet, World Wide Web, specific intranets, wide area networks, or local networks. The network 220 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 200 may include one or more server computing devices 230 having a plurality of computing devices, e.g., a load balanced server farm, that exchange information with different nodes of a network for the purpose of receiving, processing and transmitting the data to and from other computing devices. For instance, one or more server computing devices 230 may be a web server that is capable of communicating with the one or more client computing devices 202 via the network 220. In addition, server computing device 230 may use network 220 to transmit and present information to a user of one of the other computing devices 202 or a passenger of a vehicle. In this regard, vehicles 212 may be considered client computing devices. Server computing device 230 may include one or more processors, memory, instructions, data, location sensors, etc. These components operate in the same or similar fashion as those described above with respect to computing devices 202.

As shown in FIG. 2B, each device 202 may be a personal computing device intended for use by a respective user 222, and have all of the components normally used in connection with a personal computing device including one or more processors (e.g., a central processing unit (CPU)), memory (e.g., RAM and internal hard drives) storing data and instructions, an output, such as a display (e.g., a monitor having a screen, a touch-screen, a projector, a television, or other device such as a smart watch display that is operable to display information), and user input devices (e.g., a mouse, keyboard, touchscreen or microphone). The devices may also include a camera for recording video streams, speakers, a network interface device, and all of the components used for connecting these elements to one another. Devices 202 may be capable of wirelessly exchanging or obtaining data over the network 220.

Although the client computing devices may each comprise a full-sized personal computing device, they may alternatively comprise mobile computing devices capable of wirelessly exchanging data with a server over a network such as the Internet. By way of example only, devices 202 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks.

User 222 may operate a respective vehicle 212. The vehicle 212 may include a location sensor. In some examples, vehicle 212 may include an integrated navigation system. According to some examples, the navigation system may be integrated into a user's 222 respective device 202. In yet another example, the device 202 or vehicle 212 may execute a mapping application that provides maps or directions, identifies a user's location, etc.

Any use of location information or travel history of a user 222 is authorized by the respective user. For example, the user 222 may provide authorization to an application for determining travel metrics by setting certain permissions for the application. The authorization may be for the application to access one or more databases or sub-databases in the memory of the device, vehicle, remote server, etc. According to one example, the user may select specific sub-databases to which the application is granted access. For instance, the user may grant access to the location history database but not the calendar archive database.

Vehicles 212 may include a computing device (not shown). The computing device may include one or more components similar to devices 202, such as one or more processors, memory, data, instructions, a display, a user input, etc. According to some examples, vehicles 212 may include a perception system for detecting and performing analysis on objects external to the vehicle such as other vehicles, obstacles in the roadway, traffic signals, signs, trees, etc. Additionally or alternatively, the perception system may determine whether the vehicle is in motion or parked. For example, the perception system may include lasers, sonar, radar, one or more cameras, or any other detection devices which record data which may be processed by a computing device (not shown) within vehicles 212. In the case where the vehicle is a small passenger vehicle such as a car, the car may include a laser mounted on the roof or other convenient locations as well as other sensors such as cameras, radars, sonars, and additional lasers (not shown).

Storage system 240 may store various types of information. For instance, the storage system 140 may store data or information related to a user's location information, such as the user's travel history, places of interest for the user, relevant destinations, etc. In some examples, storage system 240 may store data or information related to destinations, or points of interest (“POI), for retrieval in response to a request to determine travel metrics. As used herein, POIs may include any location, or destination, that a user can visit, such as an office building, apartment complex, home address, barber shop, nail salon, big-box store, local hardware store, park, green space, restaurant, theater venue, amusement park, shopping center, etc.

Storage system 240 may store map data. This map data may include, for instance, locations of POIs, locations of driving lanes, parking lanes, designated parking areas, no parking zones, drop off locations, etc. Map data may also include locations, road names, road configurations, etc.

According to some examples, storage system 240 may store data or information related to a user's 222 location information after receiving authorization from the user 222. The authorization may be, for example, provided by setting permissions for the system to access location information and travel history. For example, a user may be provided with controls allowing the user to make an election as to both if and when systems, programs, or features described herein may enable collection of location information, and if the user is sent content or communications from a server. In addition, certain data may be treated in one or more ways before it is stored or used, so that personally identifiable information is removed. The user may have control over what information is collected about the user, how that information is used, and what information is provided to the user. The user's 222 location information or travel history may be used to identify, or determine, a user's 222 routine trips or relevant destinations.

While FIGS. 2A and 2B illustrate a single user 22 and their respective device(s) 202 and vehicle 212, it should be understood that there may be multiple users and their respective devices and vehicles. The location information and travel history of each user may be used to determine a respective user's travel history. Each user's location information and travel history may be aggregated and used to illustrate average or medial travel metrics for a given area, such as a neighborhood, town, city, county, state, etc.

Each respective user provides authorization for an application to access their location information and travel history. The user may set permissions for the application to indicate what location information and travel history the application may access. The location information may be stored locally on the user device. In some examples, the location information from the user device(s) and/or navigational applications may be shared with and, therefore, stored by one or more servers. In yet another example, the location information may be captured and stored by navigational applications. The location information and travel history may only be shared with and stored by servers after a user authorizes the sharing of location information and travel history.

### A. Travel History

Based on the user's consent or authorization, the system may collect location information and travel history for a user. The travel history may be based on location information provided by the user's personal device, applications executed by the device, a navigational system integrated into the device or vehicle, a mapping application executed by the device or vehicle, or any device having a location sensor that can illustrate the locations the user has traveled to. In some examples, the location information may be based on addresses or locations saved by the user in their contacts list, input into a mapping application when requesting directions, calendar event or calendar invites, e-mails, etc. The locations identified by the location information may correspond to a destination location for a trip or a relevant destination.

Routine v. Non-Routine Trips

Based on the user's location information, the system may determine a type of trip based on a respective starting location and destination location. A trip may include a starting location and a destination location. In some examples, the trip may include more than one destination location. The starting location may be a location selected by the user, such as a selection of a point on the map, a location received as input by the user, automatically identified by the system, etc. The destination location may be any stop during a user's travel after leaving the starting location.

The type of trip may be a routine trip or a non-routine trip. A routine trip may be a trip that occurs with an identified pattern. The pattern may be the time of day the trip occurs, the time of year the trip is taken, if the trip occurs bi-weekly, one a month, etc. In some examples, a routine trip may be a trip that occurs at or above a threshold frequency. The threshold frequency may be, in some examples, daily, three times a week, three times a month, etc. A non-routine trip may be a trip that does not occur with a pattern. In some examples, a non-routine trip may be a trip that occurs below a threshold frequency.

According to some examples, the system may identify, based on the user's location information, starting location and destination location pairs, such as the user's home address and work address, the user's home address and a coffee shop, the user's work address to a hair salon, the user's home address and a shopping center, etc. For example, the system may identify the starting location based on the address the user has identified as “home” in a navigation application, their contact list, a user selected starting location, etc. The destination locations may be identified based on locations entered into navigation applications, calendar events, e-mails, locations where travel ends, etc. A trip may include stops, or destinations, between the starting location and destination location. For example, the starting location may be the user's home address and the final destination location may be the user's work address but the user may make a stop at the coffee shop in-between to buy coffee. In another example, the starting location may be the user's work address and the final destination location may be the user's home address, but the user may stop at the gym and then the food store before reaching the final destination location, i.e., home. The system may determine a pattern or frequency for each identified starting and destination location pair.

The pattern for each identified starting and destination location pair may be, for example, whether the trip occurs on the same day of the week, at the same time each day, on the same day each month, once a month, etc. In some examples, the pattern may be whether the trip occurs during a certain part of the year, such as seasonal trips, stopping at the coffee shop for iced coffee during the summer months, or going to the gym during the non-summer months. In yet another example, the pattern may be whether the trip occurs during a certain part of the day, such as a user's daily commute to work at the same time each day.

The frequency for each identified starting and destination location pair may be, for example, whether the trip occurs once a day, multiple times a day, multiple times a week, multiple times a month, etc. For example, if the system determines, based on the user's location information or travel history, that the trip for a given starting and destination location pair is completed more than a threshold number of times in a given time period, the system may determine that pair to be a routine trip to be included when determining travel metrics. Additionally or alternatively, if the system determines that the trip for a given starting and destination location pair does not occur more than a threshold number of times in a given time period, the system may determine that pair to be a non-routine trip.

According to some examples, the system may use a machine learning (“ML”) model to determine whether a trip is a routine trip or a non-routine trip. The ML model may be trained to determine whether a trip is a routine trip. Each training example may consist of a starting location and a destination location. The input features to the ML model may be the frequency of the trip. The ML model may use the input features to more accurately determine whether the trip is a routine trip. The output of the ML model may be a determination of whether the trip is a routine trip. In some examples, the system may ask for feedback from the user. For example, the user may be asked to confirm whether the trip is a routine trip. The user may provide feedback, such as a yes or no, indicating that the determination was correct.

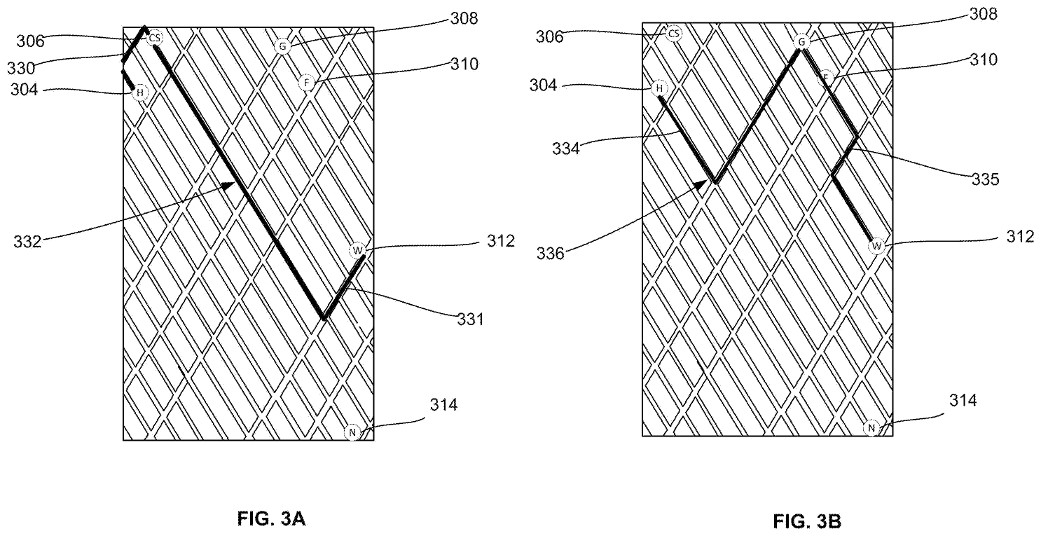

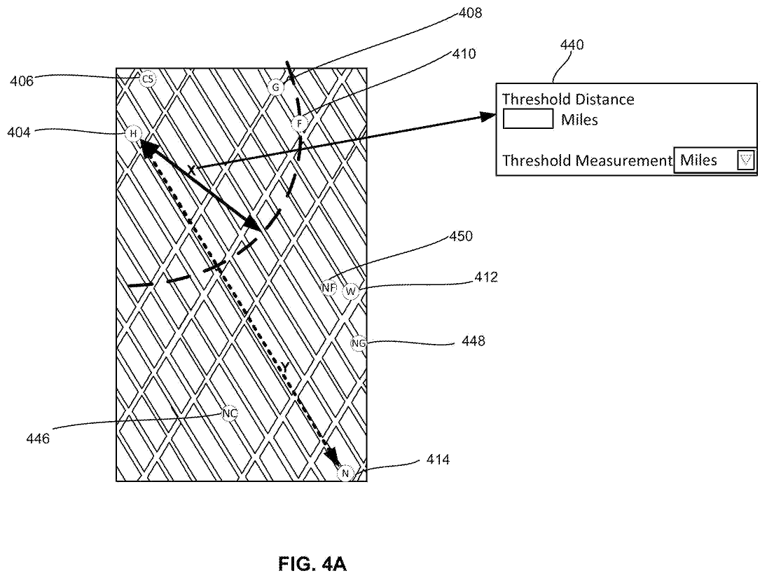

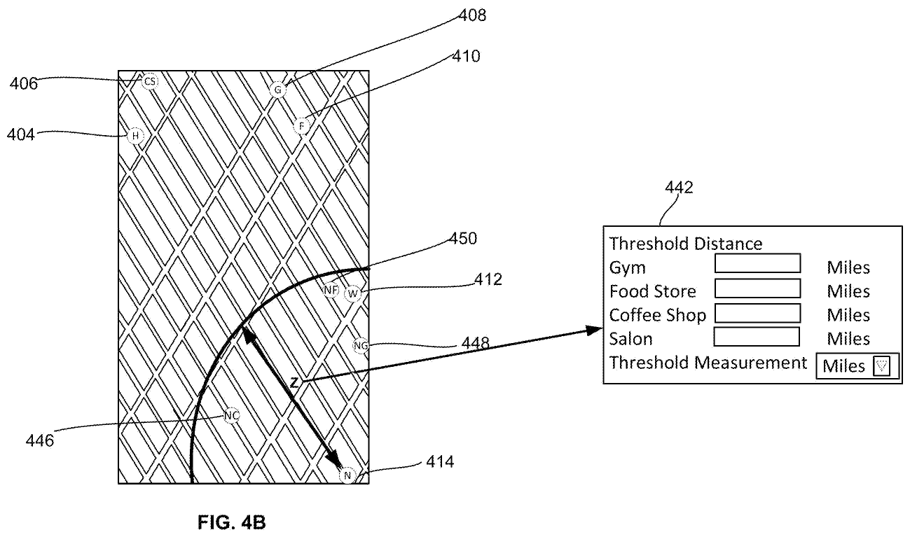

FIG. 3A illustrates an example of a routine trip. The existing starting location of a trip 332 may be the user's home location 304 and the final destination of the trip may be the user's work location 312. However, before reaching the final destination, i.e., work location 312, the user may first stop at coffee shop location 306. In such an example, trip 332 may have multiple destination locations, e.g. coffee shop location 306 and work location 312, such that trip 332 may have a first segment 330 and a second segment 331.

The system may determine that the trip 332 occurs almost daily Monday-Friday during part of the year, such as from June-August. For example, the user may stop at coffee shop location 306 every day on their way to work location 314 to purchase an iced-coffee. The system may determine that trip 332 begins at 7:15 am each time. The system may determine trip 332 to be a routine trip because trip 332 based on the frequency of the trip 332. For example, the frequency of trip 332 may be four or more days per week. A frequency of four or more days per week may be above the threshold frequency such that trip 332 is identified as a routine trip.

According to some examples, the system may determine trip 332 to be a routine trip only during certain months of the year, such as the summer months. For example, the system may determine a pattern for trip 332. The pattern may be that trip 332 only occurs during certain months, e.g. June-August. In such an example, the system may include trip 332 as a routine trip when determining travel metrics for any period of time between June-August.

In yet another example, the system may determine trip 332 to be a routine trip based on the start time of trip 332. For example, the system may determine that trip 332 begins at 7:15 am each time trip 332 is taken by the user. The system may determine that leaving at 7:15 am on a weekday is a pattern for trip 332. Based on the identified pattern, trip 332 may be a routine trip.

FIG. 3B illustrates another example of a routine trip. The existing starting location of a trip 336 may be the user's home location 304 and the final destination of the trip 336 may be the user's work location 312. Trip 336 may have a first segment 224 and a second segment 335. However, instead of stopping at coffee shop location 306, as in FIG. 3A, the user may stop at the gym 308. For example, the user may work out consistently during the non-summer months, e.g., September-June.

According to some examples, the system may determine that trip 332 changes to trip 336 during the non-summer months, e.g., September-June. The system may determine that trip 336 occurs at least three times a week. If a trip occurring at least three times a week is above the threshold frequency, the system may determine that trip 336 is a routine trip.

In some examples, the system may determine that trip 336 begins at 6:30 am each time. Additionally or alternatively, the system may determine the days of the week for trip 336. The system may determine a pattern for trip 336 based on the days of the week, the time the user leaves for trip 336, the time of the year of trip 336, etc. Based on the pattern for trip 336, the system may determine trip 336 to be a routine trip only during non-summer months, e.g., September-June. The system may, therefore, include trip 336 when determining travel metrics during a period of time overlapping with non-summer months.

According to some examples, the system may determine that the user frequents the food store 310 every Sunday morning. The system may determine the frequency of the trip to be once per week. In some examples, the system may determine the pattern of the trip to the food store to be every week, e.g., every Sunday. Based on the frequency or the pattern, the system may determine that the trip to the food store 310 is a routine trip.

In yet another example, the system may determine that the user frequents a hair salon on occasion. For example, the system may determine that the user has visited a hair salon on a Tuesday in March, a Thursday in June, a Friday in August, etc. The system may determine that there is no pattern for when the user visits the hair salon and, therefore, the trip to the hair salon is not a routine trip. Additionally or alternatively, the system may determine that the frequency of visits to the hair salon is not above a threshold frequency to be considered a routine trip. As has been described herein, various methods may be used to determine, objectively, whether a trip is a routine trip or not. Such methods therefore allow travel metrics to be assessed objectively based on an analysis of routine trips.

### Destinations and Destination Types

The user's location information, such as the user's travel history, may be used to identify destinations or destination types frequented by the user. In some examples, the destinations may be destinations frequented by the user, saved in the user's address book, identified by the user as relevant, etc.

Destinations frequented by the user may be used when determining travel metrics regardless of whether the destination is outside a given threshold. For example, the system may identify destinations of a trip as a destination to be included if the system determines a user has visited the destination more than a predetermined number of times in a given time period. In some examples, the system may receive inputs from the user identifying a destination as relevant. In such an example, the system may receive inputs for a respective destination location identifying the location as relevant, not relevant, visited periodically, etc. In some examples, the system may receive inputs identifying the destination location as a type of location, such as “work”, “coffee shop”, “doctor's office”, etc. The system may identify labeled destinations as destinations to be included when determining travel metrics.

According to some examples, the system may use a ML model to determine whether a destination is a destination to be included when determining travel metrics. The ML model may be trained to determine whether a destination should be included when determining travel metrics. Each training example may consist of a destination. The input features to the ML model may be a frequency of visiting the destination, locations in a user's contact list, locations input into a navigational system, etc. The ML model may use the input features to more accurately determine whether the destination should be included when determining travel metrics. The output of the ML model may be a determination of whether the destination should be included when determining travel metrics. In some examples, the system may ask for feedback from the user. For example, the user may be asked to confirm whether the destination should be included when determining travel metrics. The user may provide feedback, such as a yes or no, indicating that the determination was correct.

In some examples, the system may identify types of destinations, such as food stores, office buildings, doctor's office, hair or nail salon, etc. According to some examples, the system may identify destinations more generally, such as by an office park, shopping center, etc. The identified destination type may be used by the system to suggest alternative destinations of the same type to reduce travel metrics.

Using FIGS. 3A and 3B as examples, the system may identify destinations, or destination types, such as the user's current home address 304, coffee shop 306, gym 308, food store 310, and work 312. The system may identify the destinations 304-312 or destination types frequented by the user based on addresses saved in their contacts list, addresses frequently input into a navigation or mapping application, destinations identified based on location information, labels of destinations input by the user, etc. In some examples, the system may identify destinations based on trips identified as routine trips. For example, after the system identifies routine trips, the system may identify the destination location(s) of the routine trips as being relevant destinations.

### B. Outputs

### Travel Metrics

The predicted travel metrics may be determined based on the user's location information, based on objective measures as described above. For example, the predicted travel metrics may be based on trips identified as being routine trips or destinations identified as relevant destinations. Additionally or alternatively, the system may determine the travel metrics based on expected traffic and road conditions based on the predictive time of when driving has to occur. The predicted travel metrics may be determined using the identified trips or destinations in relation to a particular starting location. The predicted travel metrics may include one or more of the driving time, travel expenses, the carbon footprint, the distance driven, etc. for the predetermined period of time, such as a day, week, month, year, etc. based on the particular starting location. The particular starting location may be the user's existing starting location or a new starting location. The user's existing starting location may be, for example, the user's current home address whereas the new starting location may be a potential new home address, a vacation destination address, a rental address, etc.

The system may use the user's location information for a period of time corresponding to the predetermined period of time used to determine the travel metrics. For example, if the predicted travel metrics are for two weeks in September, the system may use the user's location information from two weeks in the most recent September when calculating the predicted travel metrics. In another example, if the predicted travel metrics are for a weeklong vacation in June, the system may use a week from the most recent June when calculating the predicted travel metrics for the vacation destination address.

In some examples, the system may determine whether to include identified destinations based on the chosen starting location. For example, the system may determine to keep destinations based on the type of location, such as a work address or a coffee shop address, while using a thresholding approach to keep other destinations. The thresholding approach may be based on a distance from the user's existing starting location, such as the user's home address, and the new starting location. If the distance between the existing starting location and the new starting location is less than a certain distance, certain destinations may be kept, whereas if the distance is greater than the predetermined distance, certain destinations may be removed when predicting travel metrics. According to some examples, the user may be able to adjust the predetermined distance for each destination type.

In one example, if the distance between the current and new starting location is less than 10 miles, the system may keep a coffee shop address as a relevant destination for determining travel metrics. In some examples, if the distance between the current and new starting location is less than 20 miles, the system may keep the address for a nail salon, doctor, dentist, barber, etc. as a relevant destination for determining travel costs. In such an example, if the distance between the current and new starting location is more than 20 miles, the system may suggest alternative destinations for a nail salon, doctor, dentist, barber, etc. based on the chosen new location. The suggested alternative destinations may be destinations of the same type that are closer to the new starting location.

FIG. 4A illustrates an example of the thresholding approach. The system may set a threshold distance “X” as the maximum distance between the existing starting location 404 and the new starting location 414. If the distance “Y” between the existing starting location 404 and the new starting location 414 is greater than the threshold distance “X”, the system may not include certain identified relevant destinations or routine trips when determining the travel metrics for the new starting location 414. In the example shown in FIG. 4A, the new starting location 414 is a distance “Y” away from the existing starting location 404. The distance “Y” is greater than the threshold distance “X”. In such an example, the system may determine that, based on the distance “Y” being greater than the threshold distance “X”, the coffee shop is no longer in the same neighborhood. The system may, therefore, suggest or identify a new coffee shop 446 location to be used when predicting travel metrics.

According to some examples, the threshold distance “X” may be set based on inputs received from the user. For example, the system may receive an input to change or adjust the threshold distance “X”. In some examples, the user's device may execute an application for predicting travel metrics. The application may provide a menu option, pop-up 440, or an overlay allowing the user to adjust the threshold distance “X”. As shown, the user may adjust the threshold distance “X” by providing a numerical input for the threshold distance “X” in miles. In some examples, the pop-up 440 may include a drop down menu, sliding scale, radio button, etc. as a way to select or set the threshold distance “X”. According to some examples, the threshold distance “X” may be set based on an estimated travel time. For example, the threshold distance “X” may correspond to a distance a user can drive in thirty minutes. Therefore, pop-up 440 for setting the threshold distance “X” in miles is merely exemplary and is not intended to be limiting.

FIG. 4B illustrates an example of the thresholding approach based on a distance from the new starting location to a destination location of a trip or a relevant destination. For example, if the distance between the chosen starting location 414 and the destination location of a trip or relevant destination 406-412 is less than a threshold distance “Z”, certain destinations may be kept, whereas if the distance between the destination 406-412 and the new starting location 414 is greater than the threshold distance “Z”, certain destinations 406-412 may not be included when determining travel metrics.

According to some examples, the user may be able to adjust the threshold distance “Z” based on a destination type. The threshold distance “Z” for each destination type may be set based on input received by the user. For example, the system may receive an input to change or adjust the threshold distance “Z” for a given destination type. In some examples, the application for predicting travel metrics executed by the user's device may include a menu option, a pop-up 442, or an overlay allowing the user to adjust the threshold distance “Z” for one or more destination types. As shown, the user may adjust the threshold distance by providing a numerical input for the threshold distance “Z” in miles for each destination type. In some examples, the pop-up 442 may include a drop down menu, sliding scale, radio button, etc. as a way to select or set the threshold distance “Z” for a given destination type. According to some examples, the threshold distance “Z” may be set based on an estimated travel time. For example, the threshold distance “Z” may correspond to a distance a user can drive in thirty minutes. Therefore, pop-up 442 for setting the threshold distance “Z” in miles is merely exemplary and is not intended to be limiting.

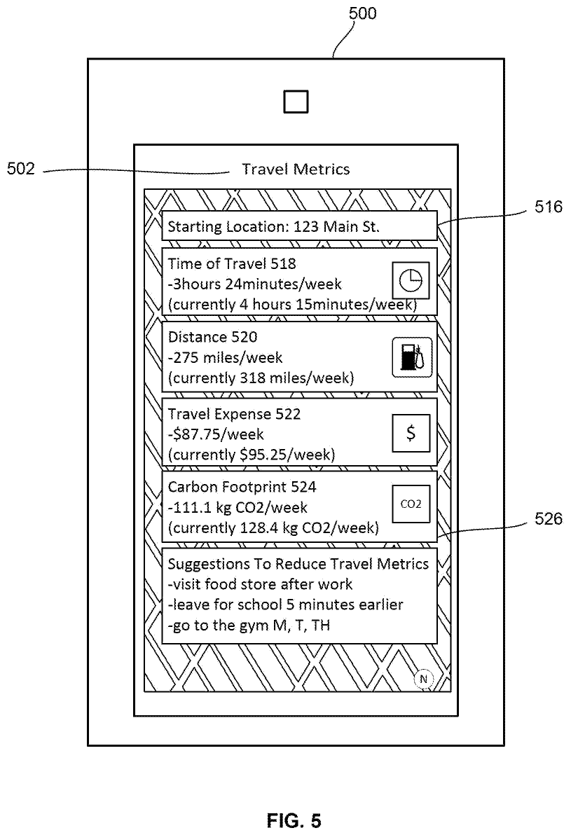

FIG. 5 illustrates example output of predicted travel metrics. While time of travel 518, distance 420, travel expenses 522, and carbon footprint 524 are all shown, the system may output only one or some of the predicted travel metrics. For example, the application 502 may include a menu option that allows the user to select which travel metrics to be shown.

The output of the system may include an identification of the new starting location 516. In some examples, the application 502 may include an input for the user to provide the new starting location. For example, the user may input an address corresponding to the address of a potential new home, a vacation address, a short term rental, etc. According to some examples, the system may select the new starting location 516 based on a home listing recently viewed by the user. In yet another example, the system may select the new starting location 516 based on a location that would decrease the user's travel metrics as compared to their existing starting location. In this manner, the user is able to obtain an objective measure of how the new starting location 516 would affect their travel metrics on the assumption that all the routine trips are maintained. As such, the described method automatically either provides a manner of determining any change in travel metrics were the user to start from the new starting location 516 (e.g. a potential new home), or is able to automatically select the new starting location 516 for the user as a location that would decrease one or more of the user's travel metrics. For example, the automatically chosen new starting location 516 may reduce the user's driving time, travel expenses, carbon footprint, or distance driven. Such metrics may be based on the assumption that the user will maintain all the routine trips, or may be based on one or more of the routine trips being replaced by a new location upon which to base a routine trip. For example, a coffee shop on the way to work, which was identified as a routine trip from the original starting location, may be replaced by a new coffee shop to form part of a new routine trip from the new starting location 516.

According to some examples, the new starting location 516 may be the existing starting location. In such an example, the predicted travel metrics may be based on the suggestions to reduce the travel metrics.

As shown in FIG. 5, the predicted travel metrics 518-524 may be output as text indicating the amount of time, distance, expense, carbon foot print, etc. per period of time, e.g., per week. However, the predicted travel metrics 518-524 may be output based on any predetermined period of time, such as a day, week, month, three months, year, etc. In some examples, the predicted travel metrics 518-524 may be output in graphical format, such as a histogram, pie chart, etc.

According to some examples, the predicted travel metrics 518-524 may include an indication of the predicted travel metrics and the current travel metrics. The current travel metrics may be the travel metrics based on the user's existing starting location, such as the user's current home address. The user may use the predicted travel metrics when evaluating the effect on the user's overall travel based on changing the user's existing starting location to the new starting location. This may be helpful, for example, when evaluating a location for a new home purchase or rental, a vacation rental, etc.

The time of travel 518 to the relevant destinations or suggested alternative destinations, based on the new starting location 516, may be 3 hours and 24 minutes per week. In contrast, the user's current time of travel 518 for their routine trips and to their relevant destinations, based on their existing starting location, may be 4 hours and 15 minutes per week. Accordingly, the user may determine, based on the time of travel 518 metric that they may save 51 minutes of travel time each week if the user changed their existing starting location to new starting location 516.

The distance 520 to travel to the relevant destinations or suggested alternative destinations, based on the new starting location 516, may be 275 miles per week. In contrast, the user's current distance 520 for their routine trips and traveling to their relevant destinations, based on their existing starting location, may be 318 miles per week. Accordingly, the user may determine, based on the distance 520 to travel metric that they may drive 43 miles less per week.

The travel expense 522 to travel to the relevant destinations or suggested alternative destinations, based on the new starting location 516, may be $87.75 per week. In contrast, the user's current travel expense 522 for their routine trips and to their relevant destinations, based on their existing starting location, may be $95.25 per week. Accordingly, the travel metrics may indicate that the user may save $7.50 each week if they changed their starting location.

The carbon footprint 524 to travel to the relevant destinations or suggested alternative destinations, based on the new starting location 516, may be 111.1 kg CO2 per week. In contrast, the user's current carbon footprint 524 for their routine trips and to their relevant destinations, based on their existing starting location, may be 128.4 kg CO2 per week. Accordingly, the user may determine, based on the carbon footprint 524 metric that they may save 17.3 kg CO2 each week if they changed their starting location.

According to some examples, the system may output suggestions to reduce travel metrics 526 with the predicted travel metrics 518-524. The suggestions to reduce travel metrics may include changing the order of destinations in a routine trip, changing the time the user leaves for a routine trip, changing the days of the week the user visits a relevant destination, etc.

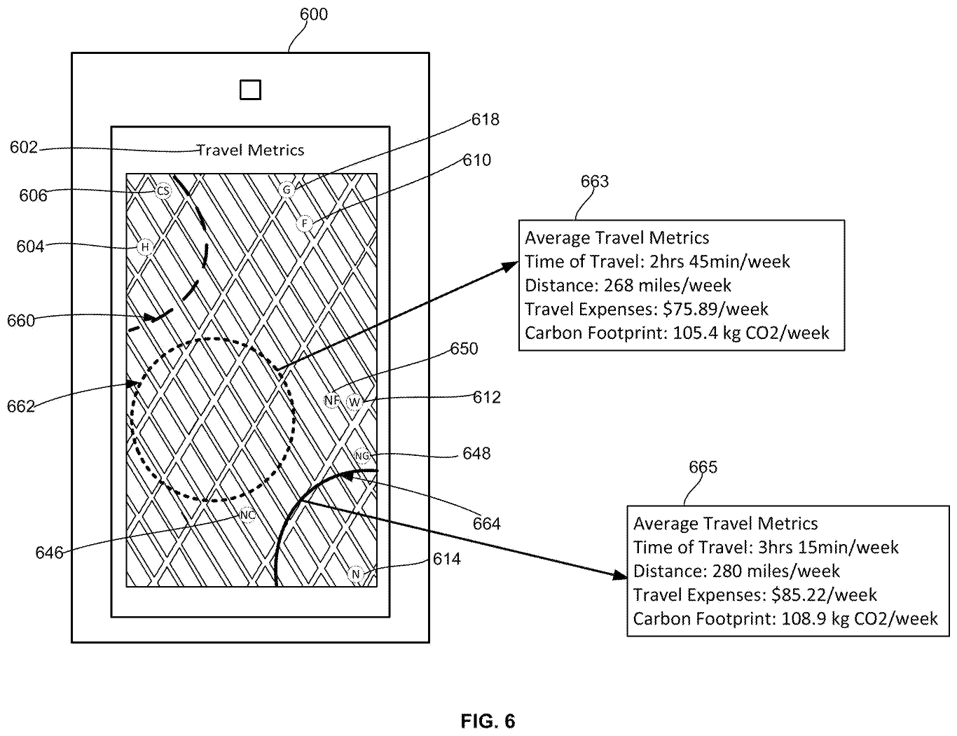

FIG. 6 illustrates example average travel metrics for a given area, such as a neighborhood, city, county, state, etc. The average travel metrics for a given area may be output as an overlay on a map.

According to some examples, the system may identify a plurality of areas in which average or median travel metrics have been determined. The areas may include area 660, area 662, and area 664. The system may determine the average travel metrics for those areas 660, 662, 664 based on the location information for user's having an existing starting address in that area 660, 662, 664. While areas 660, 662, 664 are shown as circular, areas 660, 662, 664 may have an arbitrary shape or may have a shape corresponding to the designation of a given neighborhood, town, county, state, etc. Accordingly, the shape of areas 660, 662, 664 being circular is merely one example and is not intended to be limiting.

The system may determine average travel metrics for a given area 660, 662, 664 based on location information and travel history of user's located in that area. For example, the system may determine users in areas 660, 662, 664 who have authorized location sharing. The system may determine one or more travel metrics for those respective users. Based on the determined travel metrics, the system may aggregate the travel metrics to determine an average, or median, travel metric for a given area 660, 662, 664. According to some examples, certain data, such as location information or travel history, may be treated in one or more ways before it is stored or used, so that personally identifiable information is removed.

In response to a selection of an area 660, 662, 664, the system may output the average travel metrics for the selected area 660, 662, 664. The output may include an indication of the average travel metrics as a pop-up 663, 665 or overlay. The pop-up 663, 665 may include the average travel metrics for the respective area 662, 664. For example, the pop-up 663, 665 may provide an indication of the time of travel, distance, travel expenses, and carbon footprint for user's having a starting location in that area 662, 664. In some examples, the pop-up 663, 665 may have an option for the user to switch the information from average travel metrics to median travel metrics. In yet another example, the pop-up 663, 665 may include options for the user to change the period of time from week to day, month, two weeks, three months, year, etc. Additionally or alternatively, the pop-up 663, 665 may include options for the user to change the measurement units from miles to kilometers or dollars to pounds or any other type of currency.

In some examples, the system may show a comparison of the user's current travel metrics to the average travel metrics in a given area 660, 662, 664. The comparison may indicate that the user is spending more time and money traveling than their peers in the same area. In some examples, the comparison may indicate that the user has the potential to reduce their consumption of gas or electricity and, therefore, reduce their travel expenses if they were to move to another area.

According to some examples, the overlay may be, in some example, a color coded map, a heat map, etc. with a color corresponding to a specific range of travel metrics. In some examples, the overlay may include a toggle, such as a drop down menu, allowing users to switch between distance, time, travel expenses, carbon footprint, etc. This may allow for users to compare their current travel metrics to the travel metrics of others in their area, in an area they are looking to move to, etc.

### Suggestions

The system may determine the user's current travel metrics based on their existing starting location, such as their current home address. The system may provide suggestions, based on the user's current travel metrics and location information, to reduce their travel metrics. The suggestions may include, for example, switching from a first destination of a type of destination to a second destination of the same time. For example, the system may provide suggestions to switch from one grocery store to another that is closer to the existing starting location. In some examples, the suggestions may include switching the time a user travels to the destination location. For example, if the user typically leaves for work at 7:30 am, the system may suggest leaving at 7:15 am to reduce travel metrics. The suggestions may, additionally or alternatively, include public transportation options for one or more trips. For example, the system may suggest taking a bus to work or riding a bike to the bank instead of driving in order to reduce travel metrics.

According to some examples, the system may provide suggestions to reduce their predicted travel metrics based on the new starting location. For example, the system may provide suggestions to switch from the destination identified as the gym frequently visited by the user to another gym that is closer to the new starting location. Generally speaking, and as will be described below, the system may therefore provide a suggestion to alter a first destination of a first type associated with a routine trip to a second destination of the first type, on the basis that including the second destination instead of the first destination in the routine trip would reduce one or more of the predicted travel metrics. In some examples, the suggestions may include switching the time a user typically travels to an identified destination based on expected traffic and road conditions from the new starting location. For example, the system may provide suggestions to leave the new starting location earlier than the user currently does in order to reach the destination location of the trip, such as the user's work, at the same time the user currently does from their existing starting location while also stopping at the gym.

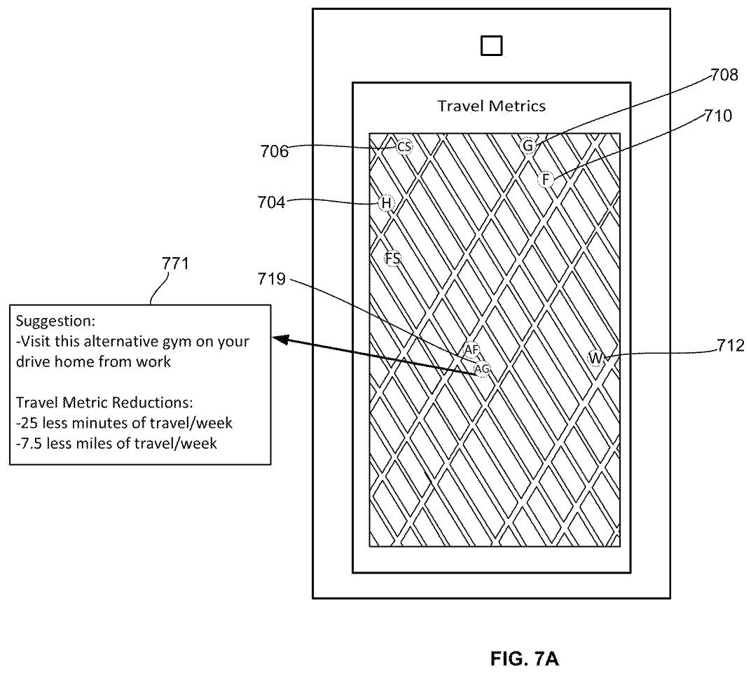

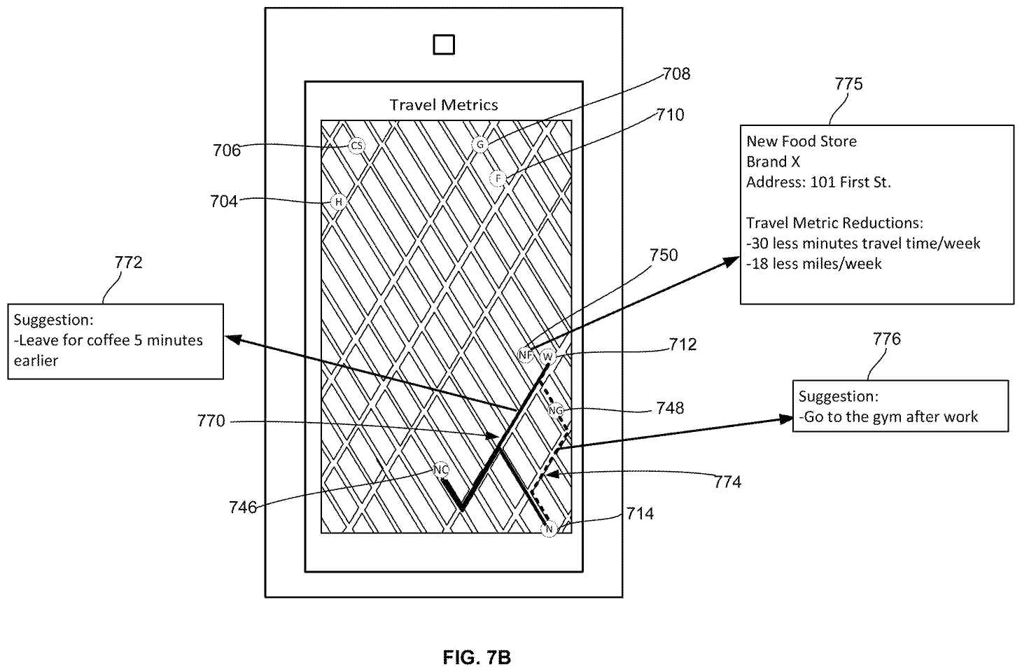

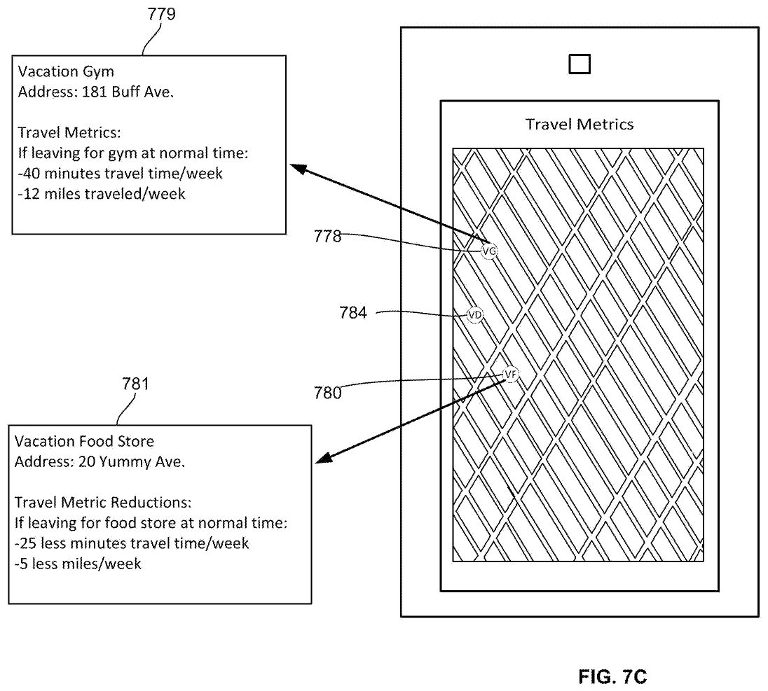

FIGS. 7A-7C illustrate example suggestions for maintaining or reducing travel metrics. Based on the type of suggestion, the suggestion may be shown as an alternative route on a map, as a pop-up or overlay, as part of a list, as shown in FIG. 5, etc. For example, if the suggestion is to change the route taken for a trip to a relevant destination, the output may include an indication of the current route and the suggested route.

FIG. 7A illustrates example suggestions for reducing travel metrics based on the user's existing starting location. For example, the user's existing starting location 704 may be the user's home address. The system may suggest alternative destinations in order for the user to reduce their travel metrics. The suggested alternative destinations may be an alternative destination of the same type of a relevant destination or a destination of a routine trip. For example, the system may suggest an alternative gym 719 for the user to frequent instead of the current gym 708. The system may suggest the alternative gym 719 due to its proximity to the user's existing starting location 704, its location along a routine trip, etc. The system may provide the suggestion as a pop-up 771 or overlay. The pop-up 711 may include the suggestion for the user to visit the alternative gym 719 on their way home from work. In some examples, the pop-up 711 may include an indication of how incorporating the suggestion would reduce a user's travel metrics.

FIG. 7B illustrates example suggestions for maintaining or reducing travel metrics based on a new starting location, such as a potential new home address. For example, the new starting location 714 may be a distance away from the existing starting location 704 greater than the threshold distance. In such an example, the system may identify new relevant destinations as alternatives to the user's existing relevant destinations. The new relevant destinations may be of the same type of the identified relevant destinations. For example, the system may suggest new gym 748 instead of gym 708, new food store 750 instead of food store 710, new coffee shop 746 instead of coffee shop 706, etc.

According to some examples, the system may provide an indication of how the new relevant locations reduce a user's predicted travel metrics. For example, the system may provide a pop-up 775 or overlay in response to a user input. The user input may be a selection of one of the new relevant locations, such as new food store 750. The pop-up 775 may provide information pertaining to the new food store 750, such as their name, address, phone number, contact information, hours, reviews, etc. Pop-up 775 may, additionally or alternatively, include an indication of how frequenting new food store 750, instead of food store 710, reduces a user's predicted travel metrics.

According to some examples, the suggestion may be to change the time the user leaves to a trip to the new relevant destination. The change in time may be in comparison to the existing time a user leaves for the trip to the relevant destination. The output may include an indication of the current route 770 and a text suggestion as to when to leave. For example, as shown in FIG. 7B, the system may provide a pop-up 772 or overlay providing a suggestion to leave for coffee 5 minutes earlier than normal based on the new starting location 714 and new coffee shop 746. The suggestion to leave 5 minutes earlier may be based on the time the user leaves the existing starting location 704 to go to coffee shop 706. The pop-up 772 may, in some examples, include additional information, such as the time saved by leaving earlier, expenses saved by leaving earlier, and/or reduction in carbon footprint by leaving earlier. According to some examples, the pop-up 772 may be in response to an input provided by the user and received by the system to obtain additional information regarding the suggestion.

In some examples, the system may provide a suggestion to change the order the user travels to relevant destinations. In such an example, the system may provide an indication of the alternative route as compared to the user's current route. Additionally or alternatively, the output may include a text suggestion indicating an alternative order to travel to the destinations. For example, as shown in FIG. 7B, the output includes an indication of alternative route 774. While not shown, the output may, in some examples, include the user's current route to the destinations. According to some examples, the user output may include a pop-up 776 or overlay providing the suggestion to go to the gym after work. In some examples, the pop-up 776 may be output in response to a user input, such as a selection of alternative route 774. The pop-up 776 may, in some examples, include additional information, such as the time saved by going to the gym after work, expenses saved by going to the gym after work, and/or reduction in carbon footprint by going to the gym after work.

FIG. 7C illustrates example suggestions for maintaining or reducing travel metrics based on a new starting location, such as a vacation destination address. The new starting location 784 may correspond to the location of a hotel, motel, bed and breakfast, rental share, vacation rental, etc. The system may determine that the new starting location 784 is a greater distance away from the existing starting location than the threshold distance. In such an example, the system may suggest new relevant destinations as alternatives to the user's existing relevant destinations. The new relevant destinations may be of the same type as the identified relevant destinations. For example, the system may suggest vacation gym 778 instead of gym 708 and vacation food store 780 instead of food store 710.

The system may receive an indication or input identifying new starting location 784 as a vacation location. In such an example, the system may not include the user's work location when predicting travel metrics as the user would not be traveling to work on vacation.

According to some examples, the system may provide an indication of predicted travel metrics if the user were to visit the new relevant destinations, e.g., vacation gym 778 and vacation food store 780, at a user's normal time or frequency. The indication may be, for example, a pop-up 779, 781 or overlay. The indication may be in response to an input provided by the user and received by the system to obtain additional information regarding the suggestion. The pop-up 779, 781 may include information pertaining to vacation food store 780 and vacation gym 778, such as their name, address, phone number, contact information, hours, reviews, etc. Pop-up 779, 781 may, additionally or alternatively, include an indication of how frequenting vacation gym 778 and vacation food store 780, reduces a user's predicted travel metrics as compared to frequenting gym 708 and food store 710. In some examples, the pop-up 779, 781 may include an indication of the predicted travel metrics if the user were to maintain their typical routine on vacation. The predicted travel metrics may be based on a user leaving the new starting location 784 for the vacation gym 778 or vacation food store 780 at their normal, or typical, time. In some examples, the predicted travel metrics may be based on the user frequenting vacation gym 778 or vacation food store 780 with their typical frequency.

While the examples shown in FIGS. 7A-7C are with respect to a specific starting location, the system may provide the suggestions shown based on any starting location. The examples provided, therefore, are not intended to be limited to the specific starting location.

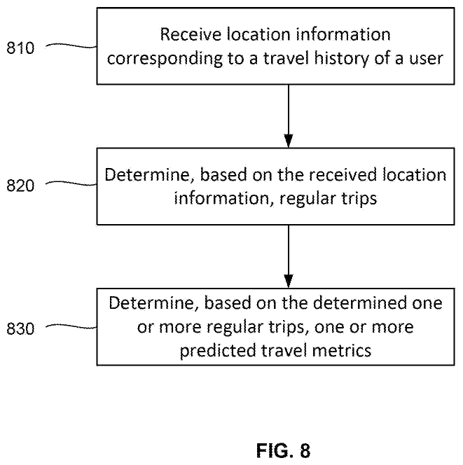

FIG. 8 illustrates an example method for determining predicted travel metrics for a user based on the user's location information and a selected starting location. The selected starting location may be, for example, a new starting location, such as a potential new home address, a vacation destination address, etc. or the user's existing starting location. The following operations do not have to be performed in the precise order described below. Rather, various operations can be handled in a different order or simultaneously, and operations may be added or omitted.

In block 810, the system may receive location information corresponding to a one or more places of interest for the user. Receiving the location information corresponding to the one or more places of interest for the user may include receiving location information from at least one of memory of a user device, one or more servers, or navigational applications. For example, the user device may be any device having a location sensor, such as a smart phone, smart watch, AR/VR headset, smart helmet, tablet, laptop, etc. The location information may be stored locally on the user device. In some examples, the location information from the user device(s) and/or navigational applications may be shared with and, therefore, stored by one or more servers. In yet another example, the location information may be captured and stored by navigational applications.

In block 820, the system may determine, based on the received location information, routine trips. Each of the routine trips may include a trip starting location and one or more destination locations. Determining the routine trips may include determining, based on the location information, a pattern or frequency of a plurality of trips. The routine trips may be identified in an objective manner, as previously described, based on the determined pattern or frequency of the plurality of trips.

According to some examples, identifying the routine trips based on the frequency of the plurality of trips may include comparing a frequency of a respective trip of the plurality of trips to a threshold frequency. The threshold frequency may be, for example, three times a week, every weekday, etc. When the frequency of the respective trip is greater than the threshold frequency, the respective trip may be a routine trip. According to some examples, the threshold frequency may be different for each type of destination location.

In some examples, routine trips may be trips that have an identifiable pattern, such as occurring weekdays at 8:30 am, occurring during specific months or seasons of the year, etc.

In block 830, the system may determine, based on the determined routine trips, one or more predicted travel metrics. The one or more predicted travel metrics may include a mileage, an amount of driving time, a carbon footprint, a driving expense, etc.

According to some examples, the routine trips may occur during a predetermined period of time. The travel metrics may be determined for a corresponding period of time. The predetermined period of time may be a day, a week, a month, multiple months, a certain season, etc.

According to some examples, the system may identify, based on the received location information, one or more destinations. The predicted travel metrics may be further based on the identified destinations.

In some examples, the system may provide, based on the identified destinations, alternative destinations. The alternative destinations may reduce the travel metrics for a user.

In yet another example, the system may receive a starting location. The starting location may be a location different than an existing starting location of the user. For example, the starting location may be a potential new home address, a vacation destination address, or any other address. In some examples, the starting location may be selected by a user, such as by selecting a point on a map or entering an address. In yet another example, the system may automatically determine the starting location. For example, the system may determine an area or location that would reduce a user's travel metrics. The system may, in some examples, determine the starting address to be the address of a house or apartment in a sale or rental listing the user was viewing. In another example, the starting location may be the user's current home address.

In yet another example, the system may determine, based on the determined one or more routine trip and the existing starting location, one or more travel metrics. For example, the existing starting location may be the user's current home address. The system may compare the predicted travel metrics for the received starting location to the travel metrics for the existing starting location. In some examples, the system may output the predicted travel metrics for the received starting location and the travel metrics for the existing starting location. The output may be, in some examples, a comparison of the predicted travel metrics for the received starting location and the travel metrics for the existing starting location. The comparison may be output as text, a graphical representation, etc.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, by one or more processors, location information corresponding to one or more places of interest for a user;
determining, by one or more processors based on the received location information, routine trips, each of the routine trips including a trip starting location and one or more destination locations; and
determining, by the one or more processors based on the determined routine trips, one or more predicted travel metrics.

2. The method of claim 1, wherein the predicted one or more travel metrics includes at least one of a mileage, an amount of driving time, a carbon footprint, or a driving expense.

3. The method of claim 1, wherein receiving the location information corresponding to the one or more places of interest for the user further includes receiving, by the one or more processors, the location information from at least one of memory of a user device, one or more servers, or navigational applications.

4. The method of claim 1, wherein determining the routine trips comprises:
determining, by the one or more processors based on the location information, a pattern or a frequency of a plurality of trips; and
identifying, based on the determined pattern or frequency of the plurality of trips, the routine trips.

5. The method of claim 4, wherein when identifying the routine trips based on the frequency of the plurality of trips, the method further comprises comparing a frequency of a respective trip of the plurality of trips to a threshold frequency, wherein when the frequency of the respective trip is greater than the threshold frequency the respective trip is a routine trip.

6. The method of claim 1, further comprising identifying, by the one or more processors based on the received location information, one or more relevant destinations, wherein the determined one or more travel metrics is further based on the identified one or more relevant destinations.

7. The method of claim 6, further comprising providing, by the one or more processors based on the identified one or more relevant destinations, one or more alternative destinations, wherein the one or more alternative destinations reduce the determined one or more predicted travel metrics.

8. The method of claim 1, wherein the one or more trips occur during a predetermined period of time and the determined one or more predicted travel metrics is for a corresponding period of time.

9. The method of claim 1, further comprising receiving, by the one or more processors, a new starting location different than an existing starting location of the user.

10. The method of claim 9, further comprising:
determining, by the one or more processors based on the determined routine trips and the existing starting location, one or more travel metrics; and
comparing, by the one or more processors, the one or more predicted travel metrics and the one or more travel metrics.

11. The method of claim 10, further comprising outputting, by the one or more processors, the one or more predicted travel metrics and the one or more travel metrics.

12. The method of claim 1, wherein a first destination location for a first trip of the routine trips is different than a second destination location for a second trip of the routine trips.

13. A device, comprising:
one or more processors, the one or more processors configured to:
receive location information corresponding to one or more places of interest for a user;
determine, based on the received location information, routine trips, each of the routine trips including a trip starting location and one or more destination locations; and
determine, based on the determined routine trips, one or more predicted travel metrics.

14. The device of claim 13, wherein the predicted one or more travel metrics includes at least one of a mileage, an amount of driving time, a carbon footprint, or a driving expense.

15. The device of claim 13, wherein when receiving the location information corresponding to the one or more places of interest for the user, the one or more processors are further configured to receive the location information from at least one of memory of a user device, one or more servers, or navigational applications.

16. The device of claim 13, wherein when determining the routine trips, the one or more processors are further configured to:
determine, based on the location information, a pattern or a frequency of a plurality of trips; and
identify, based on the determined pattern or frequency of the plurality of trips, the routine trips.

17. The device of claim 16, wherein when identifying the routine trips based on the frequency of the plurality of trips, the one or more processors are further configured to compare a frequency of a respective trip of the plurality of trips to a threshold frequency, wherein when the frequency of the respective trip is greater than the threshold frequency the respective trip is a routine trip.

18. The device of claim 13, wherein the one or more processors are further configured to identify, based on the received location information, one or more relevant destinations, wherein the determined one or more travel metrics is further based on the identified one or more relevant destinations.

19. The device of claim 18, wherein the one or more processors are further configured to provide, based on the identified one or more relevant destinations, one or more alternative destinations, wherein the one or more alternative destinations reduce the determined one or more predicted travel metrics.

20. The device of claim 13, wherein the one or more trips occur during a predetermined period of time and the determined one or more predicted travel metrics is for a corresponding period of time.

21. The device of claim 13, wherein the one or more processors are further configured to receive a new starting location different than an existing starting location of the user.

22. The device of claim 21, wherein the one or more processors are further configured to:
determine, based on the determined routine trips and the existing starting location, one or more travel metrics; and
compare the one or more predicted travel metrics and the one or more travel metrics.

23. The device of claim 22, wherein the one or more processors are further configured to output the one or more predicted travel metrics and the one or more travel metrics.

24. The device of claim 13, wherein a first destination location for a first trip of the routine trips is different than a second destination location for a second trip of the routine trips.

25. A computer-readable medium storing instructions, which when executed by one or more processors, cause the one or more processors to:
receive location information corresponding to one or more places of interest for a user;
determine, based on the received location information, routine trips, each of the routine trips including a trip starting location and one or more destination locations; and
determine, based on the determined routine trips, one or more predicted travel metrics.

26. The computer-readable medium of claim 25, wherein the predicted one or more travel metrics includes at least one of a mileage, an amount of driving time, a carbon footprint, or a driving expense.

27. The computer-readable medium of claim 25, wherein when receiving the location information corresponding to the one or more places of interest for the user, the one or more processors are further configured to receive the location information from at least one of memory of a user device, one or more servers, or navigational applications.

28. The computer-readable medium of claim 25, wherein when determining the routine trips, the one or more processors are further configured to:
determine, based on the location information, a pattern or a frequency of a plurality of trips; and
identify, based on the determined pattern or frequency of the plurality of trips, the routine trips.

29. The computer-readable medium of claim 28, wherein when identifying the routine trips based on the frequency of the plurality of trips, the one or more processors are further configured to compare a frequency of a respective trip of the plurality of trips to a threshold frequency, wherein when the frequency of the respective trip is greater than the threshold frequency the respective trip is a routine trip.

30. The computer-readable medium of claim 25, wherein the one or more processors are further configured to identify, based on the received location information, one or more relevant destinations, wherein the determined one or more travel metrics is further based on the identified one or more relevant destinations.

31. The computer-readable medium of claim 30, wherein the one or more processors are further configured to provide, based on the identified one or more relevant destinations, one or more alternative destinations, wherein the one or more alternative destinations reduce the determined one or more predicted travel metrics.

32. The computer-readable medium of claim 25, wherein the one or more trips occur during a predetermined period of time and the determined one or more predicted travel metrics is for a corresponding period of time.

33. The computer-readable medium of claim 25, wherein the one or more processors are further configured to receive a new starting location different than an existing starting location of the user.

34. The computer-readable medium of claim 33, wherein the one or more processors are further configured to:
determine, based on the determined routine trips and the existing starting location, one or more travel metrics; and
compare the one or more predicted travel metrics and the one or more travel metrics.

35. The computer-readable medium of claim 34, wherein the one or more processors are further configured to output the one or more predicted travel metrics and the one or more travel metrics.

36. The computer-readable medium of claim 25, wherein a first destination location for a first trip of the routine trips is different than a second destination location for a second trip of the routine trips.
